(19) United States
(12) Patent Application Publication
(10) Pub. No.: US 2026/0217467 A1
(43) Pub. Date: Jul. 30, 2026

(54) Conveyor Roller

(71) Applicant: Interroll Holding AG, Sant’ Antonino (CH)

(72) Inventors: Christopher Matheisen, Hüickelhoven (DE); Christian Ripperda, Hüickelhoven (DE)

(21) Appl. No.: 19/152,462

(22) PCT Filed: Jan. 26, 2024
(86) PCT No.: PCT/EP2024/051974

§ 371 Date: Jul. 31, 2025

(30) Foreign Application Priority Data
Jan. 31, 2023 (EP) 23154186.3

(51) Int. Cl. B65G 13/04; B65G 43/08

(52) U.S. Cl. CPC B65G 13/04; B65G 43/08; B65G 2203/0233; B65G 2207/10

(57) ABSTRACT

Conveyor roller (3) for a conveyor arrangement (1), including a roller tube (31) having an outer peripheral face (31S) which constitutes a support face for an object to be conveyed (9), and optionally an endcap (32) attached to the roller tube (31), a shaft (34), a bearing (33) for rotatably supporting the roller tube (31) on the shaft (34), and wherein the roller tube (31) is made from a fiber reinforced plastic.

### CROSS-REFERENCE TO RELATED APPLICATIONS

This is a US national phase entry application under 35 U.S.C. 371 of international patent application no. PCT/EP 2024/051974 filed 26 Jan. 2024, which claims priority to European patent application no. 23154186.3, filed 31 Jan. 2023; each of which is herein incorporated by reference in its entirety.

### TECHNICAL FIELD

The invention refers to a conveyor roller and a conveyor arrangement comprising a conveyor roller.

### BACKGROUND OF THE INVENTION

EP 2 778 100 B1 discloses a conveyor roller for conveyor systems for conveying containers, pallets and the like. The roller has a roller tube whose outer peripheral face constitutes a support face for material to be conveyed, and a head element which is introduced into a hollow end of a roller tube. The roller tube is supported rotatable to a roller shaft by bearings.

US 2003/0192775 A1 discloses a roller conveyor having a plurality of conveyor rollers.

DE 10 2010 005 475 A1 discloses a conveyor roller with a stationary shaft and an outer cylinder arranged rotatably thereon by means of at least one bearing. The outer cylinder is made of a wound fiber-plastic composite.

KR 10 1286174 B1 discloses a roller transporting wherein a roll pipe 3 us made of CFRP material.

A conveyor roller having an antistatic element is described in WO 2025/003231 A1, published after the priority of the present application.

Conventionally the roller tube is made from steel, which contributes heavily to the overall weight of the roller. When used with multiple start/stop operations, much power is required just to accelerate and decelerate the roller. Also the energy is required for producing the roller.

### SUMMARY OF THE INVENTION

It is an object to provide an improved conveyor roller and a roller conveyor, in particular with improved sustainability. The invention is solved by a conveyor roller and a conveyor arrangement according of the main claims; embodiments are subject of the subclaims and the description.

The invention proposes to use a roller conveyor having a roller tube made of fiber reinforced plastics. Hereby sustainability can be improved. Compared to a conventional roller tube the new roller provides the following advantages.

The weight of a roller tube of fiber reinforced plastic is significantly reduced, leading to lower required power during operation in particular when used in start/stop operations of conveying arrangement at comparable mechanical stiffness. The overall handling in the whole supply chain starting from the rare materials, manufacturing the rollers, transporting the rollers and assembling in the final location is made more power efficient.

The new roller tube can easily be made from recycled material, in particular when made with short fibers. In contrast to long, woven or wound fibers the short fibers can be obtained by shredding any components having the desired material and thereby recycling such components. (In contrast thereto, when using long fibers, the long fibers need to be aligned in a defined manner, which make it impossible to use fibers from shredding former components). By using recycled material, the ecological footprint of the roller tube can be reduced significantly.

In particular carbon fiber is more suitable for final disposal, e.g. by combustion; glass fiber is of minor advantage because glass fiber can be disposed merely as special waste. However by permanently reusing the fibers the disadvantage in disposal can be avoided.

In an embodiment a percentage of fiber within the reinforced plastic material varies within the roller tube over the radial position. In particular that starting from a radial outer position said percentage is increasing towards the radial inner direction. Having a tube material with reduced amount of fibers in the radial outer area reduces the amount of fibers which is released into the environment through abrasion. This is a preferred feature, as possible negative effects on health (caused by fibers in the breathing air) can be avoided. Already a very thin layer of reduced fiber percentage can be sufficient to achieve the above effect.

In the claimed conveyor arrangement at least one of the rollers comprise a tube material as described above.

Due to the increased heath conductivity, any motorized roller may preferably still comprise the conventional tube material. As a result in an embodiment the conveyor comprises rollers, wherein an idler roller is provided with the new tube material (fiber reinforced plastic), whereas the motorized roller is provided with a tube material made of metal. Mixing the material make use of the advantages of both materials. The invention therefore proposes to use rollers having different roller tube materials within a conveyor zone. Thereby the most suitable material is selected in a defined manner individually for each of the rollers within a roller conveyor zone.

### BRIEF DESCRIPTION OF THE DRAWINGS

An example embodiment of the invention is described in more detail with the help of the figures; herein show

FIG. 1 a conveyor zone in perspective view;

FIG. 2 a basic conveyor arrangement;

FIG. 3 a longitudinal section through an conveyor roller according to the invention;

FIG. 4 schematically the percentage of the fibers within different roller tubes in the roller of FIG. 3.

### DETAILED DESCRIPTION OF THE INVENTION

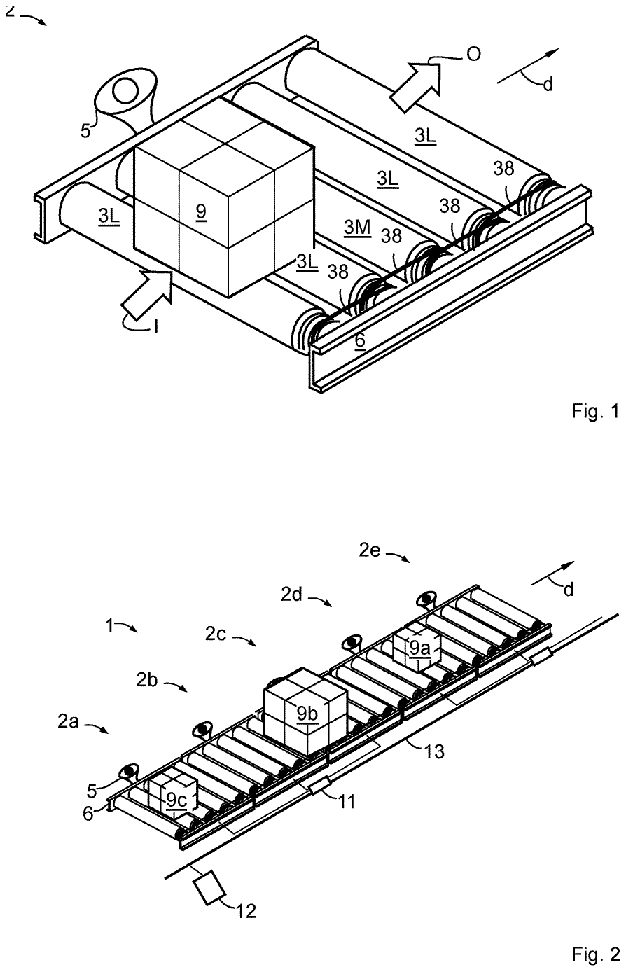

FIG. 1 shows an exemplary conveyor zone 2, comprising several conveyor rollers 3 which are driven together. For this purpose, one of the conveyor rollers is designed as a motorized conveyor roller 3M. The motorized conveyor roller 3M is driven by a, in particular three-phase, motor arranged within the conveyor roller 3M. The remaining rollers are idler rollers 3L, not comprising an internal drive motor. Via one or more drive connectors 38, e.g. a drive belt, the conveyor rollers 3 of a conveyor zone 2 are drive-connected to each other and are jointly driven by the motorized conveyor roller 3M. An object 9 is linearly conveyed from an inlet I to an outlet O along a conveying direction d.

By means of a presence sensor 5, the presence of a conveyed object 9 arranged on the conveyor zone 2 can be determined. The presence sensor 5 does not necessarily cover the entire conveyor zone 2; it is sufficient if the presence of a conveyed object 9 within a partial area of the conveyor zone 2 is detected by the presence sensor 5. The presence sensor 5 thereby generates a sensor signal, which is connected via a signal line (not shown) to a zone controller 11 presented further below.

The motorized conveyor rollers 3M are each controlled by at least one or a plurality of zone controllers 11. A single zone controller 11 can control the motorized conveyor rollers 3M of several conveyor zones 2. A plurality of zone controllers 11 are arranged in a conveyor arrangement 1 (FIG. 2), which communicate with each other via a bus connection 13.

FIG. 2 shows a basic conveyor arrangement 1, where conveyor zones 2 as described previously are used. A plurality of zone controllers 11 control the operation of the conveyor zones 2. A PLC 12 (programmable logic control) may be provided to control the overall operation of the conveyor arrangement 1.

The conveyor rollers 3 and the presence sensor 5 are attached to a support frame 6. The conveyor rollers 3 of several conveyor zones 2 can be attached to a common support frame 6.

Scanners (not shown) may be arranged along the zones and provide identification data relating to objects 9a . . . c passing the scanner in the zones. These identification data are sent via bus connection 13 to the PLC 12. The PLC 12 has access to an object data base (not shown), which provides destination data based in the identification of the objects 9. Based on the acquired data the PLC 12 provides operation instruction to a local zone controller 11, how to handle the object 9, i.e. to which of the outlets O said object 9 is to be conveyed.

In an alternative embodiment as described in European patent application 22 180 381.0, no PLC or similar is required. Instead of a PLC the zone controllers are connected to a common higher-level object data broker, in particular via the bus connection, with which the zone controllers are also connected to each other. The data broker provides destination data related to the identified objects and the zone controllers are adapted to control operation of the zones based on the provided destination data.

In particular the zone controllers 11 control the motorized conveyor rollers 3M in such a way that the successively approaching conveyed objects 9 do not collide with each other, which is usually called “zero pressure accumulation”. The control takes place in such a way that essentially only one conveyed object 9 is present per conveyor zone 2. However, slight overlaps may occur. For example, an upstream conveyed object 9b located on an upstream conveyor zone 2c may already enter a downstream conveyor zone 2d even though the downstream conveyed object 9a has not yet left this downstream conveyor zone 2d completely. Among other things, the sensor signals of the presence sensors 5 serve as input variables here, although it is ensured that the two conveyed objects 9 do not touch and thus do not damage each other.

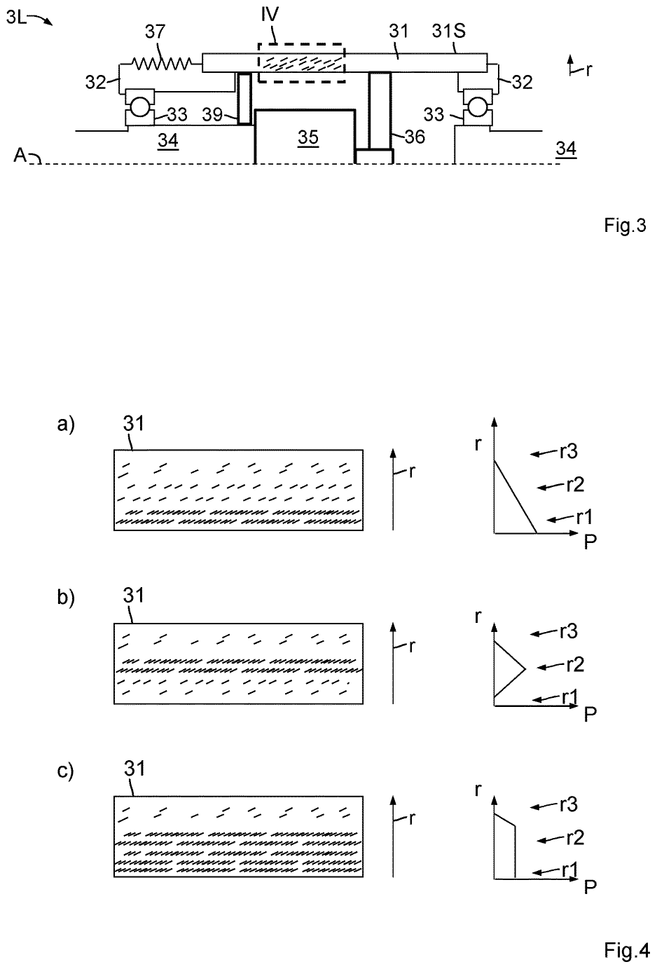

FIG. 3 shows a schematical partial longitudinal half section of the roller 3 (a motorized roller or an idler roller) of the conveyor zone of FIG. 1. The roller has a cylindrical roller tube 31. At the axial ends of the roller tube 31 endcaps 32 are attached. The endcaps 32 houses bearings 33 which are supported on a shaft 34. The roller shaft 34 may comprise two separate stub shafts, each located at an axial end of the roller tube 31.

The roller 3 comprise an attachment 37 for cooperating with the drive connector 38 (see FIG. 1). As an example the attachment 37 is an integral part of the endcap 32.

FIG. 4 shows a partial longitudinal section through the roller tube 31 according to section IV of FIG. 3. Of particular relevance is the material of the roller tube 31. Conventionally the roller tube 31 is made of steel.

According to the present invention the material of the roller tube 31 is made from a fiber-reinforced plastics. In relation to steel or other suitable metals, fiber reinforced plastics comprises a comparable mechanical strength along with lower weight. In particular the lower weight significantly reduces the power required for operating the roller in particular in start / stop operations, often used within the conveyor zones of FIGS. 1 and 2. Also the power used for overall handling during manufacturing, transport and assembling the rollers is significantly reduced.

The fiber may be made from carbon fiber. Carbon fiber is available as recycled material in good quality and large quantities. Also the material can be recycled as well. In general, due to the lower weight and the good recycling capabilities, the sustainability is increased.

The low weight roller tubes are used with in the conveyor zone of FIG. 1. In such a conveyor zone the rollers are regularly accelerated and decelerated. The lower weight provides and improved energy efficiency.

An antistatic element 39 may be provided between the shaft 34 and the roller tube 31 to dissipate electrostatic loads, in particular in case that the roller is an idler roller. To dissipate electrostatic loads, the plastic is made from a conductive material. Electrical conductive plastics are disclosed in https: //www. ensingerplastics. com/en-us/shapes/plastic-material-selection/electrically-conductive-esd.

The FIG. 4 shows a preferred distribution of the fibers with in the roller tube, where the diagram on the right side shows a schematic correlation between the radial position r and the percentage P. The percentage P of fiber in the compound is depending on the position in the radial direction (also herein called the radial position r). In the outermost radial position r3, the percentage P of the fiber is low, and may be zero. Starting from the radial outermost position r3, the percentage P of the fibers is increasing towards the radial inner direction.

In the embodiment of FIG. 4a, the percentage P of the fibers is increasing from the outermost radial position r3 via a central radial position r2 to the innermost radial position r1.

In the embodiment of FIG. 4b, the percentage P of the fibers is increasing from the outermost radial position r3 via a central radial position r2 and the percentage P is decreasing from the central radial position r2 to the innermost radial position r1.

In the embodiment of FIG. 4c, the percentage P of the fibers is increasing from the outermost radial position r3 to the central radial position r2 and remains in main constant in direction to the innermost radial position r1.

In an embodiment the conveyor zone 2 of FIG. 1 is provided with at least one roller 3, having a roller tube 31 made of fiber reinforced plastic. In particular the idler rollers 3L are provided with a roller tube made of fiber reinforced plastics. In a further embodiment the motorized roller 3M has a roller tube conventionally made from steel, since steel has the better heat conductivity to better dissipate heat generated by the motor to the outside.

In case the heat conductivity is sufficient to prevent overheating of the motor within the motorized roller, the motorized roller may also be provided with a roller tube made from reinforced plastic.

### LIST OF REFERENCE SIGNS

1 conveyor arrangement
2 conveyor zone
3 conveyor roller
3M motorized conveyor roller
3L idler roller
31 roller tube
31S outer surface
32 endcap
33 bearing
34 shaft
35 motor
36 clutch
37 attachment for drive connector
38 drive connector
39 antistatic element
5 presence sensor
6 frame
9 object to be conveyed
11 zone controller
12 PLC
13 bus connection
d conveying direction
A axis of rotation
r radial position
r1 innermost radial position
r2 central radial position
r3 outermost radial position
I inlet
O outlet
P percentage

1. Conveyor roller (3) for a conveyor arrangement (1), comprising
a roller tube (31) having an outer peripheral face (31S) which constitutes a support face for an object to be conveyed (9), and
optionally an endcap (32) attached to the roller tube (31),
a shaft (34),
a bearing (33) for rotatably supporting the roller tube (31) on the shaft (34), characterized in that the roller tube (31) is made from a fiber reinforced plastic.

2. Conveyor roller (3) according to claim 1, characterized in that the fiber is a short fiber, having an average fiber length of max. 5 mm.

3. Conveyor roller (3) according to claim 1, characterized in that the fiber is a carbon fiber.

4. Conveyor roller (3) according to claim 1, characterized in that the percentage (P) of fiber within the reinforced plastic material varies within the roller tube (31) over the radial position (r1 . . . 3).

5. Conveyor roller (3) according to claim 4, characterized in that starting from a radial outer position (r3) said percentage (P) is increasing towards the radial inner direction (r1).

6. Conveyor roller (3) according to the precedin claim 1, characterized in that that the roller is adapted to dissipate electrostatic charge between the roller tube (31) and a shaft (34) of the roller (3).

7. Conveyor roller (3) according to claim 1, characterized in that said fiber reinforced plastic is conductive.

8. Conveyor roller (3) according to claim 1, characterized by an antistatic element arranged between the roller tube (31) and the shaft (34).

9. Conveyor arrangement (1), comprising at least one conveyor roller (3) according to claim 1.

10. Conveyor arrangement (1), comprising at least one conveyor zone (2);
the conveyor zone having a plurality of conveyor rollers (3), at least one of the conveyor rollers is a conveyor roller according to claim 1.

11. Conveyor arrangement (1) according to claim 10, wherein the conveyor zone (2) having
at least one motorized conveyor roller (3M)
at least one idler roller (3L),
a drive connector (38) adapted to provide a drive connection between the motorized conveyor roller (3M) and the idler roller (3L).

12. Conveyor arrangement (1) according to claim 11, characterized in that the roller tube (31) of the idler roller (3L) is made from reinforced plastic, and that the roller tube (31) of the motorized roller (3M) is made from metal, in particular steel.

13. Conveyor arrangement (1) according to claim 9, comprising at least one or a plurality of controllers (11), adapted to control the operation of a conveyor zone (2), said controller (11) controls the operation of the conveyor zone (2) based on a sensor signal provided by a presence sensor (5);
wherein the presence sensor (5) is adapted to detect the presence of an object (9) to be conveyed (9) within the conveyor zone (2).
